(19) United States
(12) Patent Application Publication
(10) Pub. No.: US 2013/0224386 A1
(43) Pub. Date: Aug. 29, 2013

(54) PROCESS AND MEANS FOR THE TREATMENT OF GLASS OBJECTS

(71) Applicants: Leopold Mader, Neuhofen/Ybbs (AT); Vesselinka Petrova-Koch, Garching (DE); Andreas Mader, Viehdorf (AT); Stefan Schachner, Krenstetten (AT); Stephen McDonald Carney, Munchen (DE)

(72) Inventors: Leopold Mader, Neuhofen/Ybbs (AT); Vesselinka Petrova-Koch, Garching (DE); Andreas Mader, Viehdorf (AT); Stefan Schachner, Krenstetten (AT); Stephen McDonald Carney, Munchen (DE)

(73) Assignee: INOVA LISEC TECHNOLOGIEZENTRUM GMBH, Seitenstetten (AT)

(21) Appl. No.: 13/825,669

(22) PCT Filed: Sep. 22, 2011
(86) PCT No.: PCT/AT11/00389

§ 371 Date: May 9, 2013

(30) Foreign Application Priority Data
Sep. 23, 2010 (AT) A 1587/2010

(51) Int. Cl. C09D 1/02; C03C 17/02

(52) U.S. Cl. CPC C09D 1/02; C03C 17/02
USPC 427/353; 106/600; 252/301.4 F; 252/521.3; 427/372.2

(57) ABSTRACT

Plate glass, in particular soda-lime plate glass, is treated with potassium water glass in order to alter the optical properties of soda-lime plate glass, in particular its reflection behaviour. The soda-lime plate glass is thermally treated after application of potassium water glass in order to achieve additional hardening of the soda-lime plate glass. The treated plate glass can be used, in particular, for cover plates of photovoltaic modules.

The invention relates to a process and a means for the treatment, in particular for the finishing, of glass objects, in particular plate glass, in order to alter the properties thereof, in particular the optical properties thereof, such as the reflection properties of the objects, in the desired way, and at the same time to improve the mechanical strength thereof.

In particular, the process according to the invention involves the treatment (finishing) of glass, in which the treatment means (first) is present in liquid form, in particular as an aqueous, environmentally sound solution.

As an example in this respect is the treatment of glass objects, e.g., plate glass, with water glass in order to alter the properties of the glass: for example, to reduce the reflection and/or to alter the refraction index upon the transfer of light from the plate glass in a transparent object that rests on the latter and/or to improve the corrosion resistance and/or to increase the mechanical strength.

U.S. Pat. No. 2,428,357 A is concerned with a process for reducing the reflection of a translucent body. In this case, a coating, which is to be applied as a uniform film of a colloidal dispersion containing silicic acid or silicates on the glass, is to reduce the reflection, for example, of glass. The coating is then to be dried. Preferred dispersions are those that consist of sodium and potassium silicates, in particular meta-silicates (water glass).

DE 100 51 724 A1 (=EP 1 328 483 B1=WO 02/032823 A) relates to thermally prestressed, i.e., hardened glass with an abrasion-resistant, porous SiO₂ anti-reflective coating. The abrasion-resistant, porous and sintering-stable SiO₂ layer is to be obtained on the soda-lime glass with use of an aqueous coating solution with a pH of 3 to 12 containing 0.5 to 5.0% by weight of ortho-silicic acid particles [SiOₓ(OH)_{y}]ₙ, by the soda-lime glass being coated with an aqueous solution and the coating then being dried. Finally, the glass is to be hardened by tempering and cooling.

The object of the invention is to indicate a process of the above-mentioned type, which can be implemented with simple means and which makes it possible to achieve—easily and in one step—the desired action of the treatment, namely the finishing, in terms of anti-reflection and hardening of glass objects. In addition, the invention is to indicate a means with which the process according to the invention can be implemented.

This object is achieved according to the invention with a process that has the features of Claim 1.

Preferred and advantageous configurations of the treatment process according to the invention are subjects of the subclaims.

In the process according to the invention, a finely-dispersed (sprayed) and/or dissolved substance, in particular an aqueous solution of potassium-water glass, contained in, for example, a carrier gas (e.g., air or nitrogen), is precipitated on an object that is made of glass, for example plate glass, preferably that consists of soda-lime glass.

With the treatment of glass according to the invention, during glass hardening, not only is it achieved that the optical properties are altered, e.g., the reflection behavior of the glass object is reduced, but rather also that the surface of the glass object is finished and hardened, which means an elevated abrasion resistance. In addition, an improved hardening of silicone, e.g., themoplastically processible silicone elastomer, is produced on the treated glass surface.

It is advantageous in the process according to the invention that an absolutely uniform application of the means can be achieved independently of the outside shape of the object.

Another advantage of the method according to the invention is that the amount of applied treatment means is determined quite simply by selecting the time period of the treatment.

In an exemplary embodiment of the invention, the object cooled to below the dew point is exposed to the carrier gas, which contains the treatment substance dissolved or in finely-dispersed form (in particular an aqueous solution of potassium-water glass).

In addition, in an exemplary embodiment of the invention, the amount of applied treatment means can be determined by the temperature difference between carrier gas, in which the substance is dissolved or finely dispersed, and the object that is to be treated.

A sample application of the process according to the invention is the treatment of glass, in particular plate glass (preferably soda-lime glass) with potassium-water glass, which, as mentioned above, alters the properties of glass, in particular the reflection, abrasion resistance, and hardness.

Rigidified, glass-like, i.e., amorphous, water-soluble sodium and potassium silicates or their aqueous solutions from a melt are referred to as water glass.

Water glass can be produced in such a way that sodium carbonate or potassium carbonate is reacted with quartz to form sodium or potassium metasilicate with release of CO₂ according to the following reaction equation.

M₂CO₃+nSiO₂→M₂O.nSiO₂+CO₂

The cooled glass is ground to form a powder, from which liquid water glass (liquid glass) is recovered by dissolving in water at high temperatures (e.g., 150° C. at 5 bar of pressure) as a clear, colloidal, alkaline solution or else as alkaline gel (gelatin-like to solid mass).

Within the framework of the invention, it can be provided that the object that is made of glass and that is treated with potassium-water glass is heated in order to ensure that the potassium-water glass reacts with the underlying glass element, and in particular is fused, and an enamel-like surface layer (“glass skin”) is produced. This can be achieved by treatment at an elevated temperature, for example a temperature of approximately 600° C. to 650° C.

This heating can be implemented using units that are commonly used in the glass industry, as they are used for hardening glass. Such units are known from, for example, WO 97/34844 A or AT 410 087 B. In the invention, the treatment with potassium-water glass is combined with (non-contact) hardening of glass and can be implemented in particular in one step.

The subsequent heating of the treated glass object—in order to allow the potassium-water glass that is applied on the glass object to react with the underlying glass element (glass disk or glass panel) and to bond permanently with it, by an enamel-like, external layer extending into the glass element (“glass skin”) being produced on the glass element—can be combined with the hardening of the glass element, in particular the glass disk or glass panel.

The medium in which the treatment substance (e.g., water glass) is contained in a carrier gas, for example air or nitrogen (preferably: nitrogen) in finely-dispersed or dissolved form, can be achieved, for example, in that the treatment substance is sprayed into a space in which it then is present in finely-dispersed form, almost like mist. When the temperature in the medium is elevated, it can also be ensured that the treatment substance at least partially transitions into the gaseous phase, i.e., it is dissolved in the carrier gas (for example, air or nitrogen). For example, the medium is kept at room temperature.

The process according to the invention, in particular for treating plate glass panels, can advantageously be implemented with potassium-water glass in the through-going process, i.e., essentially continuously. In the treatment of glass panels with water glass implemented in the through-going process according to the process of the invention, a throughput speed of 5 to 20 m/minute, in particular 9 to 15 m/minute, can be ensured so that there is an efficient coating process.

Within the framework of the invention, consideration is also given to promoting the precipitation of the treatment means by active ingredients that are added to the medium in addition to the treatment substance. For example, in the case of water glass as a treatment substance, an organic substance can be added to the medium. This is not disruptive for the coating itself, since the organic substance in the case of subsequent heat treatment to melt the treatment means with the underlying glass element (heating from 600° C. to 650° C.) is burned or destroyed.

In the case of treatment of plate glass according to the invention, in particular for producing an anti-reflective surface and for hardening glass, the procedure in the invention can be as follows:

The glass—preferably plate glass that consists of soda-lime glass—is sprayed with a water glass atomized spray—for example in a chamber. In particular, potassium-water glass is used. Before the spraying, glass is to be preheated to 30°, so that water from the air does not precipitate on the glass.

For pretreatment, glass is to be hot-washed and flushed with regenerated water.

The atomized spray is a solution of potassium-water glass in water, whereby the spraying optionally is implemented in a chamber. Preferably, the glass is moved through the atomized spray, which exits from nozzles, at a speed of 9-15 m/minute.

The atomized spray precipitates on the glass disk and produces there a closed film, consisting of the solution of potassium-water glass in water. The solution that is precipitated on the glass forms a uniform covering on the glass surface on one side or optionally on both sides.

As the next step, the glass surface is allowed to dry or is subject to a drying step.

In a subsequent washing process, potassium that is not bonded to glass is washed out again (as soon as possible).

Then, as is common for thermal hardening, the glass is heated and cooled, so that the above-bonded amount of the applied means is sintered, and a continuous transition from the glass core to the outer nanoporous glass surface (potassium-containing) is produced in the form of a type of “skin.”

Uses of the thus produced anti-reflective glasses with hardening are, for example, photovoltaic modules and multiple insulating glass disks.

By the treatment of glass with potassium-water glass as part of the treatment according to the invention, not only are its anti-reflective properties altered, which is achieved namely in terms of an increase in anti-reflective properties (reduction of reflection), but rather prestressing is also created, since stressing, which leads to elevated scratch resistance, is produced by the incorporation of potassium ions (please note: there is no ion exchange) into the porous surface of the glass.

The process according to the invention for reducing the reflection of soda-lime glass, in particular that with a small proportion of iron, in one embodiment uses a strongly dilute, aqueous solution of potassium-water glass with a low concentration of potassium hydroxide (SiO₂:KOH, for example 3.5:1 or higher). The potassium-water glass solution can be sprayed on the sodium-lime glass (with low iron content), while thin glass plates (thickness: 2 mm or less) (non-contact) are thermally hardened. Thus, the reflection of the glass surface can be reduced by 1.5 to 2% on each side together with a hardening of the glass. This (hybrid) technology is energy-effective, since the anti-reflective treatment can be implemented at the same time with the thermal hardening. The number of post-treatment steps of plate glass is thus reduced.

The thickness of the water glass residue on the glass surface should be less than 200 nm in order to avoid creating scattering centers for visible light.

A non-contact hardening process yields the possibility to avoid waviness of flat glass (especially of glass that is thinner than 2 mm).

The (thin) antireflective-treated and thermally hardened glass, i.e., the finished glass, can be used in the solar industry (photovoltaic module, solar thermal systems) and in another industry, e.g., for LED systems.

Advantageously, the glass surface in an exemplary embodiment of the invention is conditioned before hardening and before the spraying of the potassium-water glass mixture, so that the surface of the glass (the glass must not be fresh) is hydrophilic. This is advantageous for the homogeneity of the water glass coating on the glass surface. After the layer is applied, the drying is carried out. Immediately after the surface is completely dried, potassium residue can be washed out with water at room temperature (or with low-concentration acetic acid) in order to avoid the efflorescing of the surface in the reaction of potassium with carbon dioxide and air.

The process according to the invention is extraordinary simple and can be integrated without special measures in existing process sequences. The process according to the invention produces a very resistant glass surface, since potassium atoms are incorporated into the nanoporous silicate residue of the glass element.

In the process according to the invention for the treatment of glass (with the purpose of altering its anti-reflective properties and of hardening it), for example, the following process steps can be implemented:

### 1. Pre-Cleaning/Activation

The surface of the glass is (again) made fresh in order to remove oils, fats and solid particles, e.g., cutting oil on the disk edge. For a successful treatment with the potassium-water glass solution, it is advantageous that the solution wets the glass, i.e., a through-going film and no drops/streaks are formed, i.e., potassium-water glass solution is uniformly applied on the surface of the glass that is to be treated.

An attempt should be made to keep the time span between the pre-cleaning/activation and the actual coating as short as possible, so that the surface of the glass is not further contaminated, e.g., by dust.

2. Spraying with Treatment Means

For example, soda-lime plate glass is sprayed with an aqueous potassium-water glass solution, which is applied on the plate glass that is essentially oriented in a perpendicular manner by a vertical spraying bar according to the sol-gel process. Sol-gel process is defined here as a process in which a sol that is applied on the glass is then converted into a gel by removing (evaporating) the solvent (water).

It is not so essential in this case to atomize the solution that consists of potassium-water glass that is to be applied, but rather to ensure a closed surface of the sol on the glass surface, which is achieved in particular by the hydrophilization mentioned in the item above.

### 3. Reaction Time (Drying)

The applied sol is allowed to dry to form a gel, which also can take place without a climatic chamber or special clean room conditions.

Depending on the climatic ratios and disk temperature, the drying time is between 5 minutes and 25 minutes.

The drying time can be accelerated by a(n) (slightly) elevated temperature of the plate glass and/or heat panels and/or (slight) convection with dry air.

It is advantageous that the sol be dried completely to form gel, since otherwise the danger exists that large components of the layer are removed, and spots are visible in the surface of the plate glass.

Good coating of the surface is indicated when a bluish-violet gleam can be seen in the daylight.

### 4. Subsequent Cleaning

The purpose is that with a large volume of tempered osmosis water (conductivity of less than 30 microsiemens), as much unbonded potassium as possible is dissolved from the layer. A small amount of bonded potassium is to remain in the non-porous surface and has the effect that it hardens the surface and increases the corrosion resistance. Unbonded potassium would corrode on the surface (reaction with carbon dioxide in the air) and impair the transmission of light.

5. The layer is compressed and the bond with the glass substrate is

strengthened by thermal hardening of the coated glass.

Another possibility considered within the framework of the invention consists in the properties of glass, after the treatment according to the invention, being added to the potassium-water glass additives. Such additives can be dyes, e.g., a white dye (such as zinc oxide), which enhances the reflection behavior, a substance producing fluorescence or a substance that makes the layer that is obtained and is present in the surface of the glass after the treatment electrically conductive.

Below, embodiments of the invention are presented.

### EXAMPLE 1

In this example, 2.1 mm-thick white glass with dimensions of 550×360 mm are provided with an anti-reflective surface.

The procedure is as follows:

The glass is washed in the washing machine with approximately 40° hot water. Then, the glass surface is treated with a flame. Then, glass is again washed with the washing machine with 40° hot water. Then, a glass surface is sprayed with an aqueous potassium-water glass solution. Then, there is a waiting period until the spraying agent has reacted with the glass in the area of its surface, which takes approximately 10 to 15 minutes.

The solution that was used for spraying had the following composition of 96-97% water and 3-4% solid proportions (SiO₂, potassium, . . . ), whereby the potassium content of the liquid is less than 1% and a proportion of solid of 3.33% is present in the coating material.

Then, the glass is flushed again with 40° hot water.

Then, the glass was subjected to a thermal hardening, whereby a non-contact procedure was carried out.

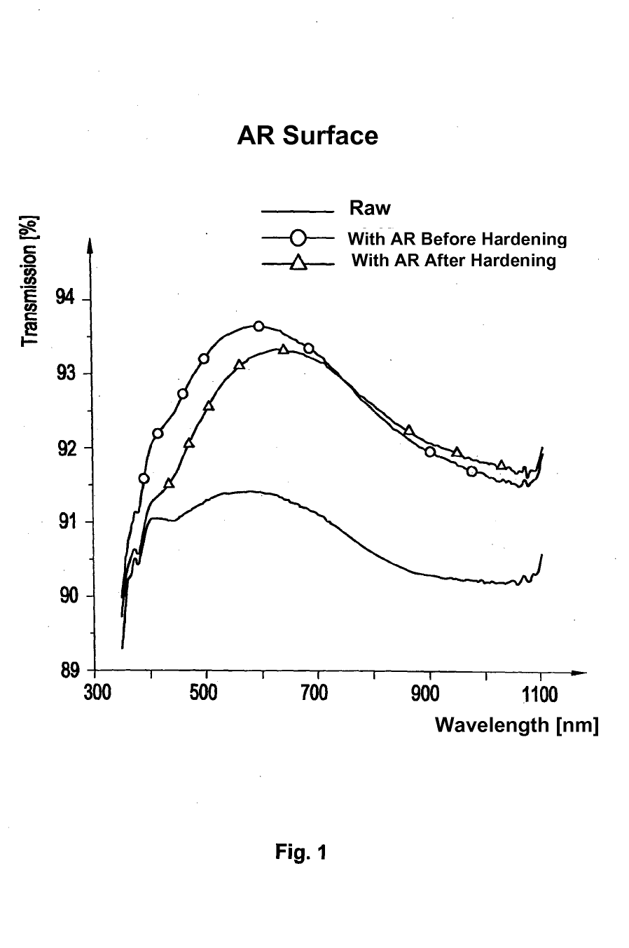

The permeability levels (transmissions), which are shown in the diagram of FIG. 1, were the result.

### EXAMPLE 2

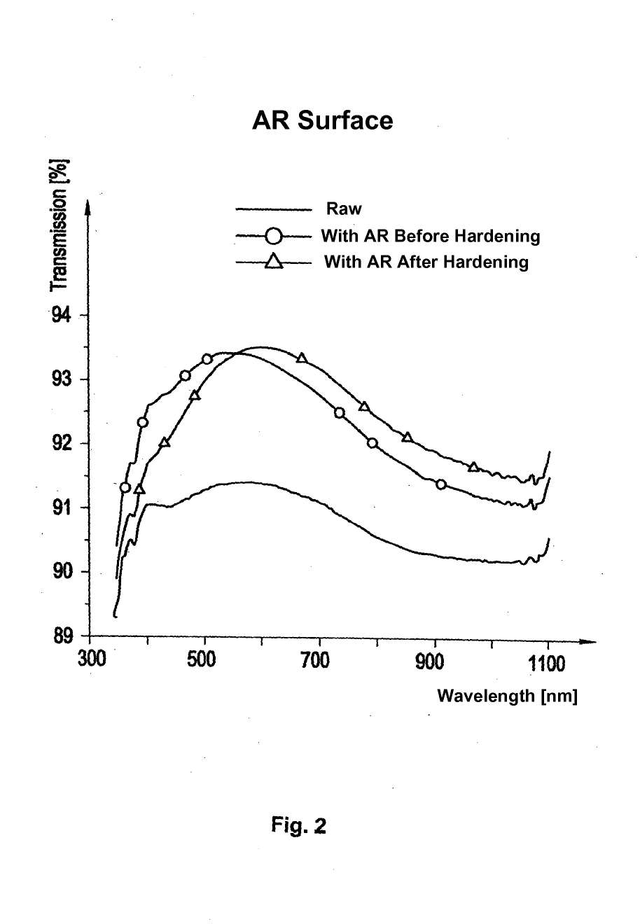

With the method of operation indicated in Example 1 and with use of the means mentioned there, three pieces of glass disks were treated on one side with K-water glass and hardened. In this test, the transmission values reproduced in the diagram of FIG. 2 were determined.

### EXAMPLE 3

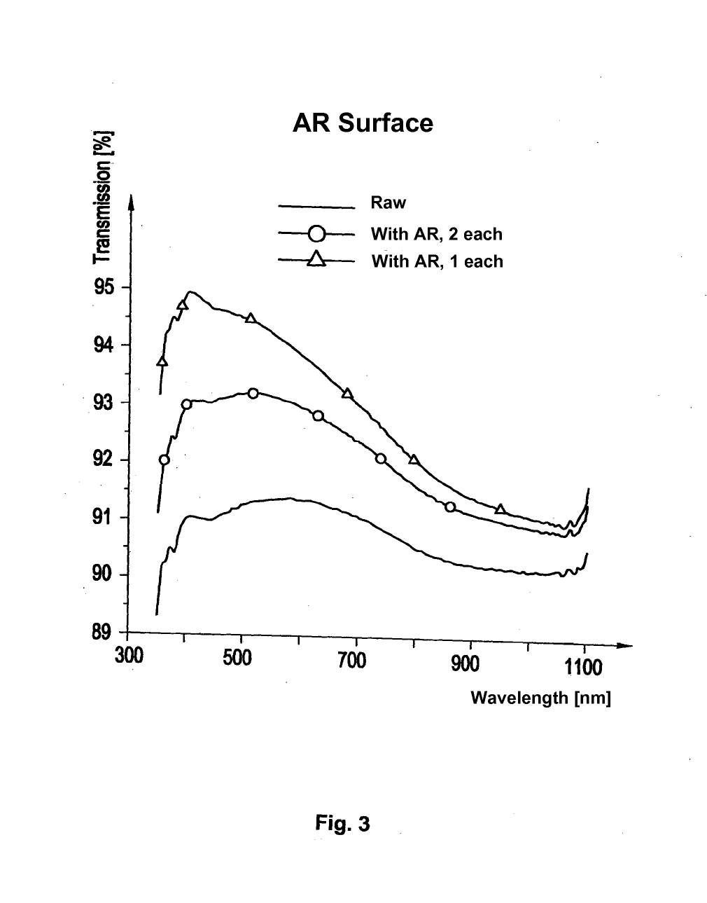

With the method of operation and the means, which are mentioned in Example 1, thin nanoporous glass skin was produced. In one disk, one-third of the surface was untreated, one-third of the surface was coated on one side, and one-third of the surface was treated on both sides. In the case of subsequent disks, they were coated once each and treated on both sides. In this test, the transmission values according to FIG. 3 were achieved.

In all tests, a hardness was produced according to the ‘pencil test’ (DIN 55350-18, ISO 15184), even in the hardest stage of the test (hardness H9).

In the hardest stage, hardness H9, of the ‘pencil test’ (ISO 15184), no damage to the surface resulted.

With a (non-standardized) scratch test, with a scratch depth of 50 nm, it was noted in a reproducible manner that the treated surface is equally hard to harder than a soda-lime-silicate glass surface.

In the case of layer thicknesses of less than 200 nm, in particular a layer thickness of 104 nm, the purpose of the tests was to achieve the desired reduced reflection values, elevated hardness, and scratch resistance, at least equal to untreated sodium-lime glass (float glass).

In summary, an embodiment of the invention can be described as follows.

Plate glass, in particular soda-lime plate glass, is treated with potassium-water glass in order to alter the optical properties of soda-lime plate glass, in particular to reduce its reflection behavior. After the application of potassium-water glass, the soda-lime plate glass is heat-treated to achieve in addition a hardening of the soda-lime plate glass. The treated plate glass can be used in particular for cover plates of photovoltaic modules.

1. Process for treating objects made of glass, characterized in that the object, preferably a plate-glass disk, in particular a plate-glass disk made of soda-lime glass, is treated with potassium-water glass and then heat-treated, in particular hardened.

2. Process according to claim 1, wherein the object is treated with a solution of potassium-water glass.

3. Process according to claim 1, wherein the object is sprayed with a solution that contains potassium-water glass.

4. Process according to claim 1, wherein the object is purified before treatment with potassium-water glass.

5. Process according to claim 1, wherein the solution that contains potassium-water glass is applied on the object in an uninterrupted layer.

6. Process according to claim 1, wherein the layer that is applied on the object is allowed to dry.

7. Process according to claim 1, wherein potassium that is not bonded to the object is washed out from the nanoporous surface.

8. Process according to claim 1, wherein the object for heat treatment is heated to a temperature in the range of 600 to 650° C., preferably non-contact, and then is cooled again to room temperature.

9. Process according to claim 1, wherein a solution is used that in water contains 3 to 4%, preferably 3.4%, solids of the potassium-water glass.

10. Process according to claim 1, wherein the object is treated with an open flame after purification and before coating.

11. Process according to claim 1, wherein unbonded potassium is washed out from the porous surface.

12. Process according to claim 11, wherein the time span is 10 to 15 minutes.

13. Process according to claim 1, wherein during cleaning and/or during washing-out of potassium, it is washed with approximately 30 to 50° C., in particular with 40° C., hot water.

14. Process according to claim 1, wherein the object is heated before the treatment to a temperature of between 20 and 40° C., preferably to approximately 30° C.

15. Process according to claim 1, wherein for washing-out, water regenerated from unbonded potassium, in particular water with a conductivity of less than 50 yS, preferably less than 30 yS, is used.

16. Process according to claim 1, wherein when plate glass is being treated, the latter is treated essentially oriented vertically.

17. Process according to claim 16, wherein the solution that contains potassium-water glass is sprayed on the plate glass from nozzles arranged vertically above one another.

18. Process according to claim 1, wherein the object that is made of glass is treated on one side, in particular is made anti-reflective.

19. Process according to claim 1, wherein the object that is made of glass is treated on both sides, in particular is made anti-reflective.

20. Process according to claim 1, wherein the coating of the object that is made of glass and that is present in the form of water glass is converted by heating into a nanoporous skin on the surface of the glass object.

21. Process according to claim 20, wherein for producing the nanoporous surface from water glass, the object that is made of glass is heated to a temperature on the order of 600° C. to 650° C.

22. Process according to claim 20, wherein after the heating of the object that is made of glass and that is present as plate glass in order to melt water glass with the plate glass, it is abruptly cooled in order to harden the plate glass.

23. Means for implementing the process according to claim 1, wherein the means is an aqueous solution of potassium-water glass.

24. Means according to claim 23, wherein the means contains 1 to 6% by weight, preferably 3 to 4% by weight, of solids of potassium-water glass, dissolved in water.

25. Means according to claim 24, wherein the means contains less than 2% by weight, in particular less than 1% by weight, of potassium.

26. Means according to claim 23, wherein at least one substance—from the group that consists of dye, in particular mineral dye, a substance triggering fluorescence and a substance ensuring conductivity—is added to the means.
